(19) United States
(12) Patent Application Publication
(10) Pub. No.: US 2006/0184514 A1
(43) Pub. Date: Aug. 17, 2006

(54) Large-scale metasearch engine

(76) Inventors: Weiyi Meng, Vestal, NY (US); Vijay Raghavan, Lafayette, LA (US); Zonghuan Wu, Lafayette, LA (US); Clement Yu, Northbrook, IL (US)

Correspondence Address: Russel O. Primeaux - Kean, Miller,;Hawthorne, D'Armond, McCowan & Jarman LLP, P. O. Box 3513, Baton Rouge, LA, 70821-3513, US

(21) Appl. No.: 11/184,040

(22) Filed: Jul. 22, 2004

(51) Int. Cl. G06F 17/30; G06F 7/00

(52) U.S. Cl. 707/3

(57) ABSTRACT

A large-scale metasearch engine is provided. The engine has three main components. A discovery component examines web page content to discover and identify search engines. A connection component connects the metasearch engine to each search engine that has been identified. A search result extraction component extracts useful information from each result page returned from said search engines for any particular query. A method for a query of internet pages by use of the novel metasearch engine is also provided.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “SEQUENCE LISTING,” A TABLES OR A COMPUTER PROGRAM

Not Applicable.

### BACKGROUND OF THE INVENTION

1. Field of the Invention

The present invention relates to search engines used for searching web pages. More particularly, the invention relates to a meta search engine which uses automatic search engine discovery, automatic search engine connections, and automatic search engine result extraction techniques.

2. Description of Related Art

Metasearch engines support unified access to hundred of thousands of search engines. A significant problem in building a very large scale metasearch engines is the impracticality to manually identify and incorporate these search engines. Even if all the relevant search engines could be identified and incorporated, maintenance of such a metasearch engine would be extremely time-consuming. The owners and operators of search engines make changes on a regular basis. These changes will often render a search engine unusable for incorporation into a metasearch engine, unless corresponding changes are made in the metasearch engine. Therefore, manual maintenance is not practical.

The inventors believe that the entire process of search engine identification and incorporation, as well as metasearch engine maintenance should be automated.

Both the traditional crawler-based “Surface Web” search engines and “Deep Web” databases that have Web search interfaces are categorized as Web search engines.

In this application the term “search engine interface,” or alternatively “search engine page” will be used for a Webpage from which users can type in queries. The inventors assume that for any existing search engine interface, there is at least one HTML form that can be used to submit queries. To identify such forms is of crucial importance in discovering the existing search engine interfaces.

After a query is sent to a search engine, a result page is returned. Usually, retrieved documents are listed on a result page with their descriptions and URLs. Some other important information about the search (such as the number of retrieved documents for a query) result may also be present, depending on the nature of the search engine.

Most metasearch engines discover component search engines manually. The maintenance of the listing of component search engines is time-consuming and inefficient.

For metasearch engines with a large number of component search engines, automated connection to search engine interfaces is an essential requirement because manual connection analysis is time-consuming and unfeasible. Additionally, manual connection creates difficulty in tracking occasional search engine interface changes.

Early manual approaches to result extraction have had many recognized shortcomings, mainly due to the difficulty in wrapper construction and maintenance.

What is needed is a large scale meta search engine that integrates and automates all of the features which are desirable in meta search engines.

It is an object of the present invention to provide a metasearch engine which does not require manual input of the search engines to be used.

### SUMMARY OF THE INVENTION

The large scale metasearch engine of the present invention includes three main components: (a) a program to automatically discover and identify search engines, (b) a program to automatically connect to search engines, and (c) a program to automatically extract query results from the search engines. In a preferred embodiment, the metascarch engine will also find the URLs of returned documents and find the number of returned documents. When a user enters a query into the large scale metasearch engine, the query is automatically dispatched to the search engines discovered by the metasearch engine. In a particulary preferred embodiment, when the query results are returned to the metasearch engine, the metasearch engines automatically merges the results from the various search engines for the convenience of the user.

The present invention has several advantages over the prior art systems. One advantage of the present invention is that it does not require manual input of search engines.

Another advantage of the present invention is that it the user of the metasearch engine does not need to understand web search technology.

Another advantage of the present invention is that it assembles metasearch engines seamlessly and instantly at the time the search is conducted, thereby discovering the most recent search engines.

These and other objects, advantages, and features of this invention will be apparent from the following description.

### BRIEF DESCRIPTION OF THE DRAWINGS

FIG. 1 is an example of how a web page being examined might appear in HTML code form.

### DETAILED DESCRIPTION OF THE INVENTION

The novel large-scale metasearch engine includes three major components. Component (1) is the automatic search engine discovery component. This component of the invention will discover and identify search engines from millions of Websites on the Web. Component (2) is the automatic search engine connection component. This component automatically connects the metasearch engine to each search engine being used so that user queries submitted to the metasearch engine are forwarded to search engines and search results from search engines are returned to the metasearch engine. Component (3) is the automatic search result extraction component. This component performs the function of extracting useful information from each result page returned from a search engine for a query, such as the number of retrieved documents for the queries, the URL of the retrieved documents, and other information which may be helpful to the overall evaluation of the query posed to the metasearch engine.

Component One of the Metasearch Engine, the Automatic Search Engine Discovery component, will now be described. The discovery component uses a two step process to identify search engines. The two steps are crawling and filtering.

In step 1, crawling, the invention employs a special Web crawler to fetch Webpages. Those skilled in the art are familiar with Web crawlers and these crawlers can be adapted to the collection of web pages for later filtering in step 2 below. Each Webpage is regarded as a potential search engine interface page.

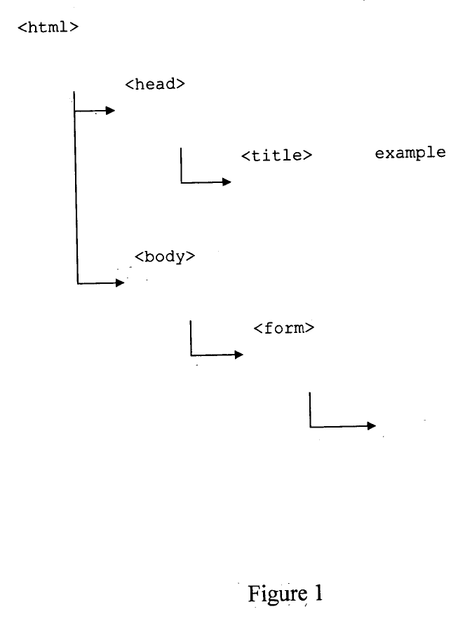

In step 2, filtering, a set of recognition rules is applied to the Web pages obtained in the crawling step. Using this set of recognition rules, the metasearch engine determines if a Web page has a search engine interface. The main filtering rules that could be employed in one preferred embodiment are shown below. A Web page must include all three of the items listed below in order to be recognized as a search engine interface page and therefore survive the filtering step. The three items are:
(1) The HTML source file of a potential search engine interface page should contain at least one HTML form.
(2) The HTML form must also have a text input control for query input.
(3) The potential search engine interface page should contain at least one keyword from the following keyword set: “search,” “query” or “find.” The keyword must appear either in the “<form>” tag or in the text immediately preceding or following the “<form>” tag. The keyword set could be modified to adapt to different criterion or different webpage programming languages (known or unknown) that might be employed in the future. An example of how-a web page being examined might appear in code form is shown in FIG. 1.

The second component of the metasearch engine is the automatic connection component. In one preferred embodiment the automatice connection component of the invention will include four steps.

In Automatic Connection Step 1 the invention will parse the HTML source code into a tree structure of HTML tags. FIG. 1 is the tree structure presentation for the following simple HTML page:

<html>

<head>

<title>example</title>

</head>
<body>

<form> . . . </form>

</body>

</html>

Automatic Connection Step 2 will include extracting form parameters and attributes from the Form sub-tree and saving those form parameters in an XML formatted file as the search engine description file of the search engine. Automatic Connection Step 3 will include reading the form information from the search engine description file and reconstructing a test query string. In the last step, Automatic Connection Step 3, the invention will send the test query. The results of the test query will be evaluated to determine if the automatic connection has been successful.

The third component of the novel metasearch engine is the Search Engine Result Extraction. In one preferred embodiment of the invention, two pieces of information will be extracted from the returned page: (1) the URLs and/or snippets of retrieved Webpages and (2) the total number of retrieved documents. The automatic result extraction process includes two steps.

In Extraction Process Step 1 a so-called “impossible query” (a query consisting of a non-existent term) is sent. All URLs on the result page are useless in terms of document retrieval. These URLs are recorded and easily excluded from result pages for other queries. The layout pattern of the “Result Not Found” page is also recorded for future reference.

In Extraction Process Step 2 three program-generated queries are sent. The result pages are compared against each other and all the common URLs are marked as useless.

In a particularly preferred embodiment the metasearch engine will include two additional features. These additional features will include finding the URLs of returned result documents and finding the number of matched documents.

Finding the URLs of the returned result documents will now be described. The patterns of result document URLs on the same result page can be very similar. In one preferred embodiment the instant invention includes a unique feature called “Tag Prefix” to represent the layout pattern. The Tag Prefix of a URL is a sequence of html tags that appear before a URL and typically on the same line as the URL.

For example, a section of HTML code may look like this:

<table> <tr> <td> <b> <a href=http://url1.html>url1
Caption</a> </b> </td> </tr> . . . </table>

For this code, the tag prefix of the URL http://url1.html includes only the code string “<tr><td><b>”, and not “<table>” because the tag “<tr>” implies change of a line. Other tags indicating such a change include “<p>”, “<br>”, “<table>”, “<hr>”, “<LI>”, and other tags familiar to those skilled in the art.

Lastly, the metasearch engine will find the number of matched documents. Information concerning the number of matched documents usually appears either at the beginning or at the bottom of a result page on a text line. The matched document information may be set apart by specific features. These features include but are not limited to (a) number symbols, (b) special keywords (e.g. “found,” “returned,” “matches,” “results,” etc.), (c) the “of” pattern (e.g. “1-20 of 200”), or (d) the query terms. This line is called the “document hits” line and will be automatically extracted.

In a particularly preferred emobidment the metasearch engine will include)a search engine selection component. When this component is included, the metasearch engine will not provided all results from all search engines. Rather, this component will select a small number of search engines from which to include results. The selection will be based on the representative information obtained from the underlying search engines.

Experiment 1

An experiment was carried out to evaluate the Search Engine Discovery Component of the instant invention. The experiment included the following steps.
1. The RDF dump from http://dmoz.org, was downloaded. DMOZ is said to be the largest human-edited directory, containing millions of Webpages. A total of 519 Webpages are collected as a result of random selection, each having at least one form.
2. A manual check revealed that 307 of the 519 pages contain at least one search engine form.
3. The discovery program reported 286 search pages from the same collection of 519 Webpages.
4. 286 URLs appeared in both the manual check and the report from the discovery program. 21 URLs were listed only in the manual check, meaning that the search engine discovery component missed 21 search engines. There was no misclassification. The discovery success rate is 93% (286/307).

In almost all the 21 cases, it is the failure to locate “search”, “find” or other keywords within the search engine forms that leads to the search engine not being discovered. In one case, however, the form is written in Flash instead of regular HTML.

### Experiment 2

This experiment was conducted to test the search engine connection component of the metasearch engine. The experiment included the steps listed below.
1. The search engine connection component was used on the 286 search engine pages that were previously discovered in Experiment 1. From those 286 search engine pages, the search engine connection component identified 326 search engine forms had also been identified. It should be noted that one page may contain more than one search engine form.
2. A sample query was sent to each search engine using the search engine connection component. As a control measure the sample query was also sent to each search engine using a browser.
3. The result pages retrieved by the connection component and through the browser were compared.

The comparison showed that that 242 search engine forms were successfully connected. 18 search engines were not working properly. Additionally, 9 search engine forms using Google's processing agent allows access only via a browser. Any effort to connect using a program is effectively denied. The connection success rate is over 80% (242/(326-18-9)).

Among the 57 cases of unsuccessful connection, most forms either adopt Javascripts or are coded with poor HTML grammar, which prevent the connection component from being able to correctly parse the code. In a few cases, there is site redirection that the program fails to track.

1. A large-scale metasearch engine, comprising:
(1) an automatic search engine discovery component for discovering and identifying search engines from web pages;
(2) an automatic search engine connection component for connecting said metasearch engine to each said search engine discovered and identified in Step 1; and
(3) an automatic search result extraction component for extracting useful information from each result page returned from said search engines for a query.

2. A method for a query of internet pages by use of a metasearch engine and multiple pre-existing search engines, said method comprising the following steps.
(1) using an automatic search engine discovery component of said metasearch engine to discover and identify search engines from web pages;
(2) using an automatic search engine connection component of said metasearch engine to connect said metasearch engine to each said search engine discovered and identified in Step 1; and
(3) using an automatic search result extraction component to extract useful information from each result page returned from said search engines for a query.
